(19) United States
(12) Patent Application Publication
(10) Pub. No.: US 2026/0148620 A1
(43) Pub. Date: May 28, 2026

(54) GAMING DEVICES AND METHODS FOR OPERATING A GAMING DEVICE

(71) Applicant: NOVOMATIC AG, Gumpoldskirchen (AT)

(72) Inventor: Adam ZABINI-PHILLIPS, Gumpoldskirchen (AT)

(21) Appl. No.: 18/893,654

(22) Filed: Sep. 23, 2024

(51) Int. Cl. G07F 17/34; G07F 17/32

(52) U.S. Cl. CPC G07F 17/34; G07F 17/3213

(57) ABSTRACT

Various examples relate to a gaming device. The gaming device comprises a display device, a processor arrangement comprising at least one processor, and a memory arrangement for storing a plurality of instructions, which when executed by the processor arrangement, cause the processor arrangement to: cause the display device to display a graphical environment comprising a matrix of symbol positions for displaying a plurality of symbols, wherein the matrix of symbol positions is formed by intersections of at least one row intersecting a plurality of columns or at least one column intersecting a plurality of rows and wherein the plurality of symbols comprises a crash symbol and at least one multiplier symbol that is assigned a multiplier value; receive information related to a wager value for play of a game and a signal initiating play of the game; cause display of random selections of one or more symbols of the plurality of symbols in the matrix of symbol positions; if the at least one multiplier symbol is displayed in the matrix of symbol positions, add the assigned multiplier value of the at least one multiplier symbol to a multiplier value memory; stop play of the game if the crash symbol is displayed in the matrix of symbol positions or if a collect signal is received; and cause display of an outcome of the game.

### TECHNICAL FIELD

Various examples described herein relate to games of chance and in particular to gaming devices including new and improved ways of displaying or animating on at least one display and methods for operating a gaming device including new and improved ways of displaying or animating on at least one display.

### BACKGROUND

Gaming devices, machines or consoles, such as slot machines, are popular within the gaming environment, and are one of the basic elements of the gaming industry. Game developers continue to invent new and innovative ways of displaying and representing games, gameplay, and awards.

### SUMMARY

Various examples relate to new and improved gaming devices including new and improved ways of displaying or animating on at least one display, and methods for operating a gaming device including new and improved ways of displaying or animating on at least one display.

Various examples relate to a gaming device, comprising a processor arrangement comprising at least one processor and a memory arrangement for storing a plurality of instructions. The plurality of instructions, when executed by the processor arrangement, causes the processor arrangement to: (a) cause the display of a graphical environment on a display device, wherein the graphical environment comprises a matrix of symbol positions for displaying a plurality of symbols, wherein the matrix of symbol positions is formed by intersections of at least one row intersecting a plurality of columns or at least one column intersecting a plurality of rows; (b) receive information related to a wager value for play of a game; (c) receive a signal initiating play of the game; (d) cause display of random selections of one or more symbols of the plurality of symbols in the matrix of symbol positions, wherein the plurality of symbols comprises a crash symbol and at least one multiplier symbol that is assigned a multiplier value; (e) add the assigned multiplier value of the at least one multiplier symbol to a multiplier value memory if the at least one multiplier symbol is displayed in the matrix of symbol positions; (f) stop play of the game if the crash symbol is displayed in the matrix of symbol positions or if a collect signal is received; (g) cause display of an outcome of the game.

Various embodiments relate to a method of operating a gaming device. The method comprises causing display of a graphical environment on a display device, wherein the graphical environment comprises a matrix of symbol positions for displaying a plurality of symbols, wherein the matrix of symbol positions is formed by intersections of at least one row intersecting a plurality of columns or at least one column intersecting a plurality of rows. The method comprises receiving information related to a wager value for play of a game. The method comprises receiving a signal initiating play of the game. The method comprises causing display of random selections of one or more symbols of the plurality of symbols in the matrix of symbol positions, wherein the plurality of symbols comprises a crash symbol and at least one multiplier symbol that is assigned a multiplier value. The method comprises adding the assigned multiplier value of the at least one multiplier symbol to a multiplier value memory if the at least one multiplier symbol is displayed in the matrix of symbol positions. The method comprises stopping play of the game if the crash symbol is displayed in the matrix of symbol positions or if a collect signal is received. The method comprises causing display of an outcome of the game.

### BRIEF DESCRIPTION OF THE FIGURES

Some examples of apparatuses and/or methods will be described in the following by way of example only, and with reference to the accompanying figures, in which:

FIGS. 1A to 1H show schematic illustrations of a gaming device according to various embodiments;

FIGS. 2A to 2H show schematic illustrations of examples of play of a game executed by a gaming device according to various embodiments;

FIGS. 3A to 3D show schematic illustrations of further examples of play of a game executed by the gaming device according to various embodiments;

FIGS. 4A and 4B show schematic illustrations of further examples of play of a game executed by the gaming device according to various embodiments;

FIGS. 5A and 5B show schematic illustrations of further examples of play of a game executed by the gaming device according to various embodiments;

FIG. 6 shows schematic illustrations of further examples of play of a game executed by the gaming device according to various embodiments;

FIG. 7 shows a flow chart of a method for operating a gaming device according to various embodiments;

FIGS. 8A and 8B show schematic illustrations of a gaming system according to various embodiments; and

FIG. 9 shows schematic illustrations of a system or a gaming system according to various embodiments.

### DETAILED DESCRIPTION

The detailed description of various embodiments makes reference to the accompanying drawings, which show the exemplary embodiments by way of illustration. Thus, the detailed description herein is presented for purposes of illustration only and not for limitation. Throughout the description of the figures, the same or similar reference numerals refer to the same or similar elements and/or features, which may be identical or implemented in a modified form while providing the same or a similar function. The thickness of lines, layers, and/or areas in the figures may also be exaggerated for clarity.

It will be understood that when an element is referred to as being “connected” or “coupled” to another element, the elements may be directly connected or coupled or via one or more intervening elements. If two elements A and B are combined using an ‘or’, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements. If a singular form, such as “a”, “an”, and “the” is used and the use of only a single element is not defined as mandatory either explicitly or implicitly, further examples may also use several elements to implement the same function. If a function is described below as implemented using multiple elements, further examples may implement the same function using a single element or a single processing entity. If the terms “include”, “including”, “comprise” and/or “comprising” are used, they describe the presence of the specified features, integers, steps, operations, processes, elements, components, and/or a group thereof, but do not exclude the presence or addition of one or more other features, integers, steps, operations, processes, elements, components and/or a group thereof. Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of suitable protocols or communication methods.

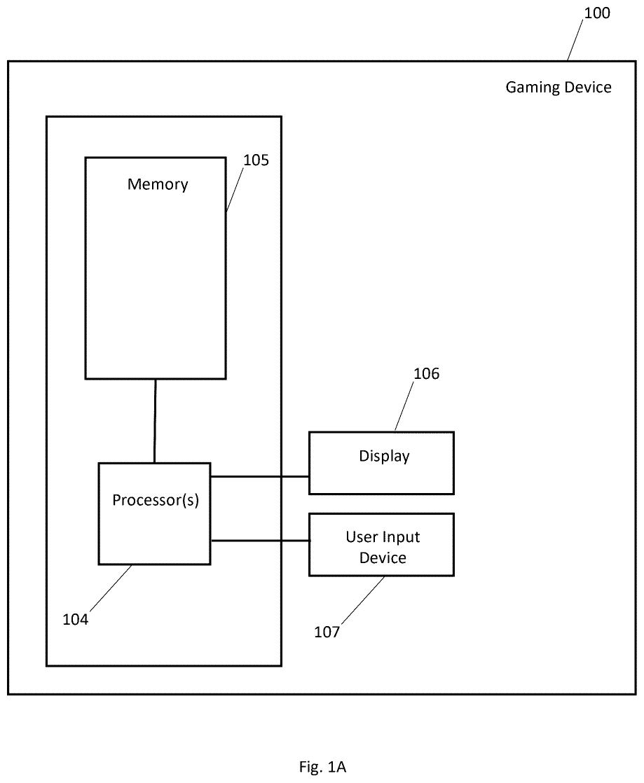

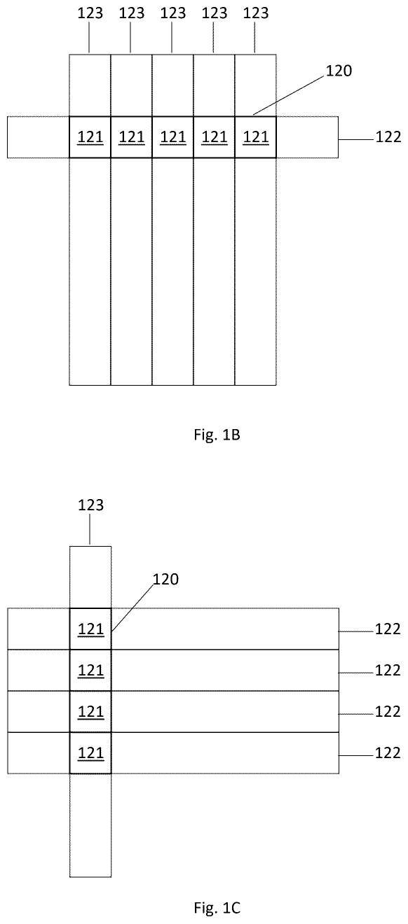

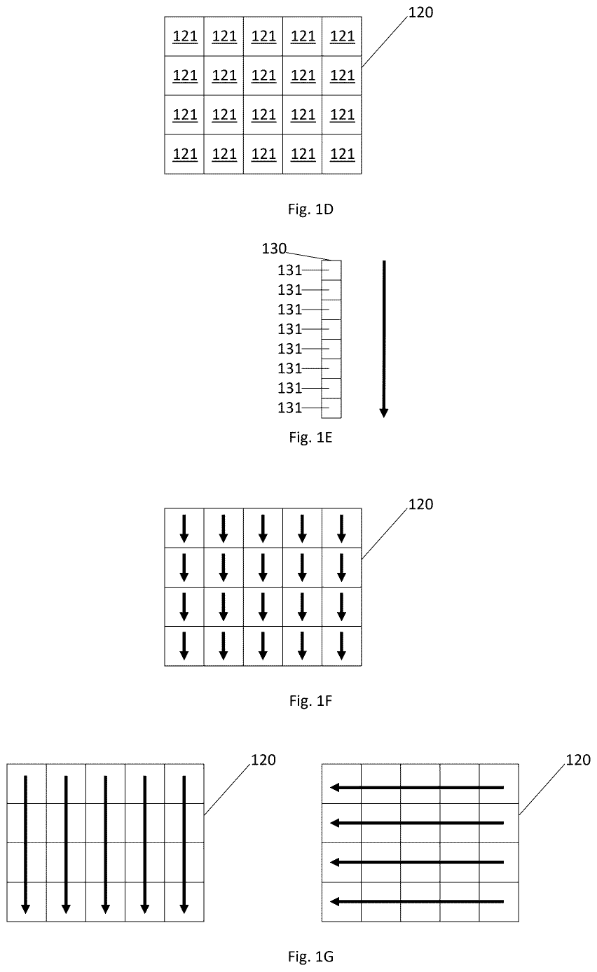

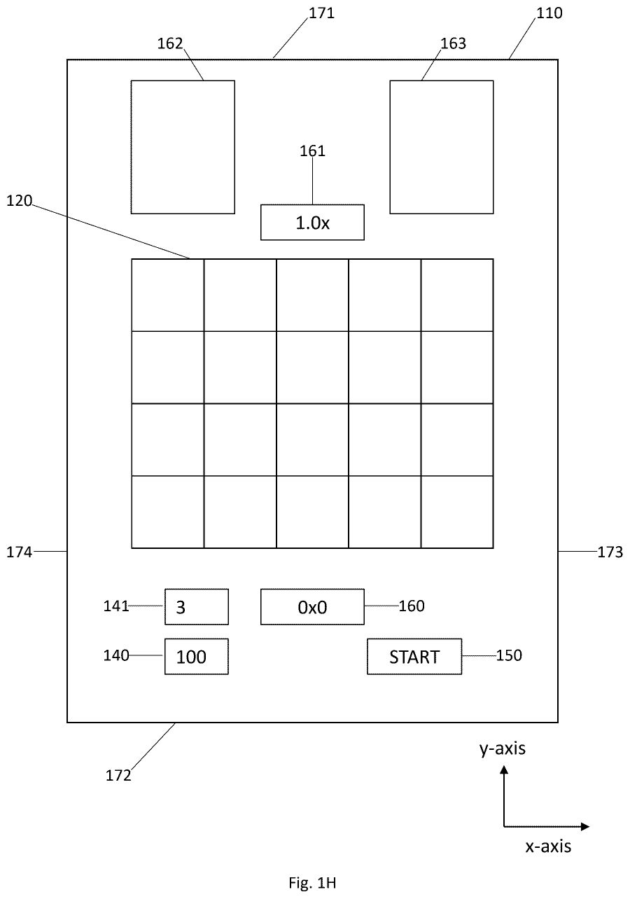

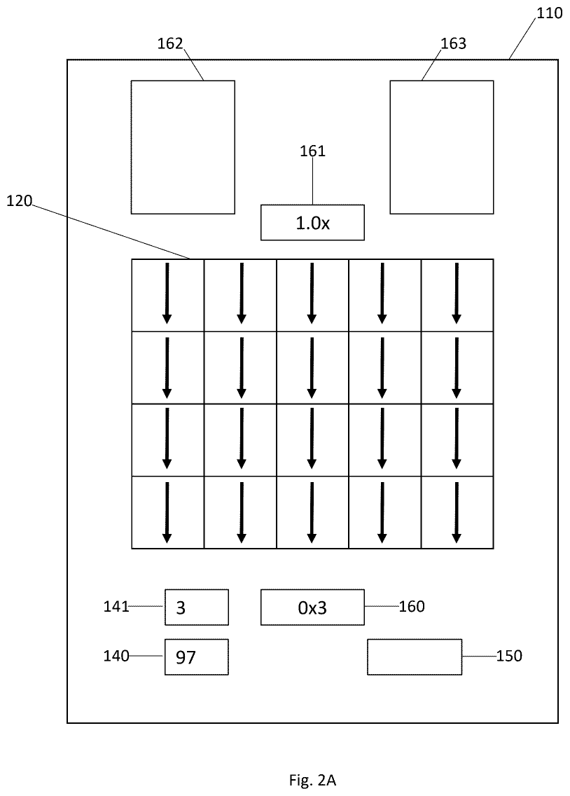

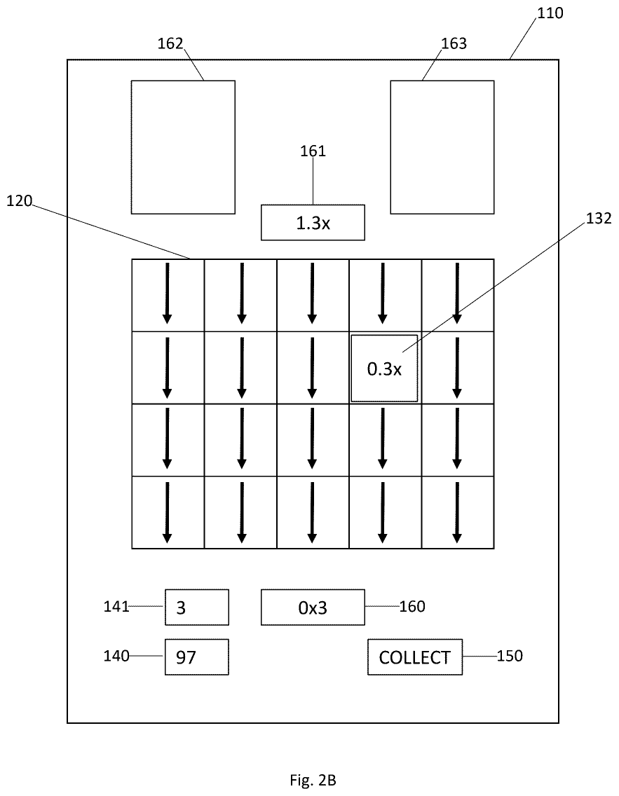

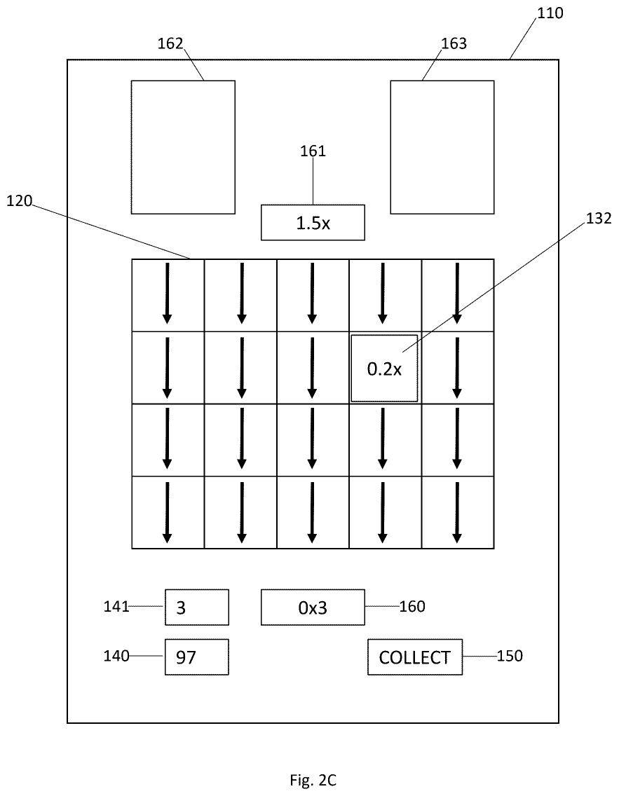

FIGS. 1A to 1H show schematic illustrations of a gaming device according to various embodiments.

As shown in FIG. 1A, the gaming device 100 may comprise a processor arrangement 104 comprising at least one processor, and a memory arrangement 105 for storing a plurality of instructions, which when executed by the processor arrangement 104, causes the processor arrangement 104 to:
(a) cause display of a graphical environment on a display device, wherein the graphical environment comprises a matrix of symbol positions for displaying a plurality of symbols;
(b) receive information related to a wager value for play of a game;
(c) receive a signal initiating play of the game;
(d) cause display of random selections of one or more symbols of the plurality of symbols in the matrix of symbol positions, wherein the plurality of symbols comprises a crash symbol and at least one multiplier symbol that is assigned a multiplier value;
(e) add the assigned multiplier value of the at least one multiplier symbol to a multiplier value memory if the at least one multiplier symbol is displayed in the matrix of symbol positions;
(f) stop play of the game if the crash symbol is displayed in the matrix of symbol positions or if a collect signal is received;
(g) cause display of an outcome of the game.

The graphical environment may be displayed on a display 106. The display 106 may be a display device such as a display screen or monitor. The environment or the graphical environment referred to in the examples, may include or may refer to the gaming area where the game takes place. As shown in FIG. 1H, the graphical environment 110 may have a two-dimensional layout, which is displayed on a two-dimensional display screen. For example, the graphical environment 110 may have a first horizontal axis (parallel to an x-axis) and a second vertical axis (parallel to a y-axis). In addition, the graphical environment 110 may have a top side 171 (parallel to the x-axis) and a bottom side 172 (parallel to the x-axis) as well as a right side 173 (parallel to the y-axis) and a left side 174 (parallel to the y-axis).

A graphical environment may be presented in a graphical user interface (GUI). A GUI manages the interaction between a computer system and a user through graphical elements on a display. A GUI may comprise various components such as icons, menus, buttons, and windows that enable users to manipulate and control software. These components may be dynamic and respond to various factors or inputs as explained further below. The GUI operates by receiving user input through devices such as a mouse or touch screen, interpreting the input, and providing visual feedback to the user. Additionally or optionally, elements of the GUI may be activated or controlled by dedicated physical hardware devices such as a button, lever, or knob. For example, a GUI may receive input from a dedicated “play” button that a user presses and the GUI interprets it as input.

During the play of the game, the graphical environment 110 includes a matrix of symbol positions 120. The matrix of symbol positions 120 is formed by intersections 121 of at least one row 122 intersecting a plurality of columns 123, as shown in FIG. 1B, or at least one column 123 intersecting a plurality of rows 122, as shown in FIG. 1C. Preferably the matrix of symbol positions 120 is formed by intersections 121 of three or four rows intersecting five columns. FIG. 1D shows a matrix of symbol positions 120, which is formed by intersections 121 of four rows intersecting five columns.

For causing display of random selections of one or more symbols of the plurality of symbols in the matrix of symbol positions 120, reel strips comprising symbols of the plurality of symbols are spun and randomly stopped. FIG. 1E shows a reel strip 130 comprising a plurality of symbol positions 131. Each symbol position 131 contains a single symbol of the plurality of symbols. Optionally, a reel strip 130 may comprise one or more symbol positions 131 containing no symbol of the plurality of symbols, thus being empty. A symbol of the plurality of symbols may be contained in multiple symbol positions 131 of a reel strip 130. Optionally, a symbol of the plurality of symbols may be contained in more than one adjacent symbol position 131 of a reel strip 130 and/or in adjacent symbol positions 131 of more than one adjacent reel strip 130 such that the symbol is split into parts, which are contained in adjacent symbol positions 131. Each reel strip 130 is spun in an endless loop. This is symbolized by the arrow in FIG. 1E. The arrow indicates the direction of rotation of the reel strip 130. A reel strip 130 can be assigned to a single intersection 121 of the matrix of symbol positions 120 or to a column or a row of the matrix of symbol positions 120. FIG. 1F shows an embodiment, in which each intersection 121 of the matrix of symbol positions 120 is assigned its own reel strip 130. When the spinning of the assigned reel strip 130 is stopped, a single symbol position 131 of the reel strip 130 is aligned with the intersection 121 of the matrix of symbol positions 120 to which the reel strip 130 is assigned. FIG. 1G shows on the left five reel strips, each of which is assigned to one of the five columns of the matrix of symbol positions 120. On the right, four reel strips are shown, each of which is assigned to one of the four rows of the matrix of symbol positions 120. In the embodiment shown on the left of FIG. 1G, four consecutive symbol positions of a stopped reel strip are aligned with the four intersections of the column to which the reel strip is assigned, whereas in the embodiment shown on the right of FIG. 1G five consecutive symbol positions of a stopped reel strip are aligned with the five intersections of the row to which the reel strip is assigned. Thus, an intersection 121 of the matrix of symbol positions 120 constitutes a position for placing and displaying a symbol or a part of a symbol. The reel strips can be spun and stopped simultaneously or independently of each other. In a preferred embodiment, spinning of the reel strips is started simultaneously for all reel strips when play of the game is initiated. During the play of the game, the reel strips are stopped independently of each other. Thus, a reel strip can be stopped while another reel strip is still spun. Furthermore, spinning of a stopped reel strip can be restarted while another reel strip is still spun or stopped. This is described in more detail below.

Elements of the graphical environment 110 or of the GUI can be any digital media that is a static or moving image (e.g., rendered 3D object, motion graphics animation, photo image, movie, etc.). An active area, sometimes called a target area, may be a property of an element that allows for interaction with the element. It is the area or field on or around a GUI element (e.g., button, icon, feature) that when touched will cause the GUI element to be activated (e.g., the button/icon is clicked). The active area is sometimes identical to the visual shape of the element as it appears on the screen but is independent of its visual appearance. For example, many irregular-shaped interface elements comprise a rectangular active area that allows for ease of interaction. So, when a user attempts to select an irregular element, they are not required to touch within the visual borders of the element but can, rather, select the element by touching within its larger and more convenient active area. The target or active area is often hidden from the user; however, its presence may be indicated in various ways. For example, an active area may be highlighted as the user's finger approaches the element or screen. Or the active areas may be shown to the user visually, for example, through subtle visual indication or with a brief animation.

Play of the game may be initiated based on a user input at a user input interface. For example, the user (or player) may cause payment of a credit, which is added to a credit meter. The processor arrangement may include credit control circuitry, which controls the credit meter based on the amount of credit received by a credit input interface. As an example, the initial credit added to the credit meter may be $100 or 100 credit points, which is displayed on the credit meter 140 shown in FIG. 1H.

After receiving payment of a credit, the processor arrangement may cause a user input device 107 to allow some input values to be input by the user. For example, the user may be given the option to select a wager value (or bet amount). The wager value is the cost for playing one round (or the cost for one play) of the game. A number of consecutive rounds (or plays) of the game form a gaming session. The selected wager value may be displayed in a bet display. In the example shown in FIG. 1H, the user has selected the wager value (or cost of each round of the game) to be $3 or 3 credit points, which is displayed in the bet display 141.

The play of one round of a game may include the initiation of play by the user, for example, by triggering a play button. Optionally, the play button may be present in the graphical environment. Alternatively, the play button may be a physical button or knob. As shown in FIG. 1H, the graphical environment 110 comprises a button 150 titled “START” for initiating the play of the game.

An outcome of the game (or game outcome or award or win) is the result of the play of one round of a game. As shown in FIG. 1H, the graphical environment 110 comprises an award display 160 for displaying the game outcome. Preferably, the game outcome is determined by multiplying the wager value with an accumulated multiplier value, which is displayed in a multiplier display 161. The determining of the accumulated multiplier value is described below. Values of the accumulated multiplier value and the game outcome of preceding rounds of the game are listed in a history display 162 and a wins display 163, respectively.

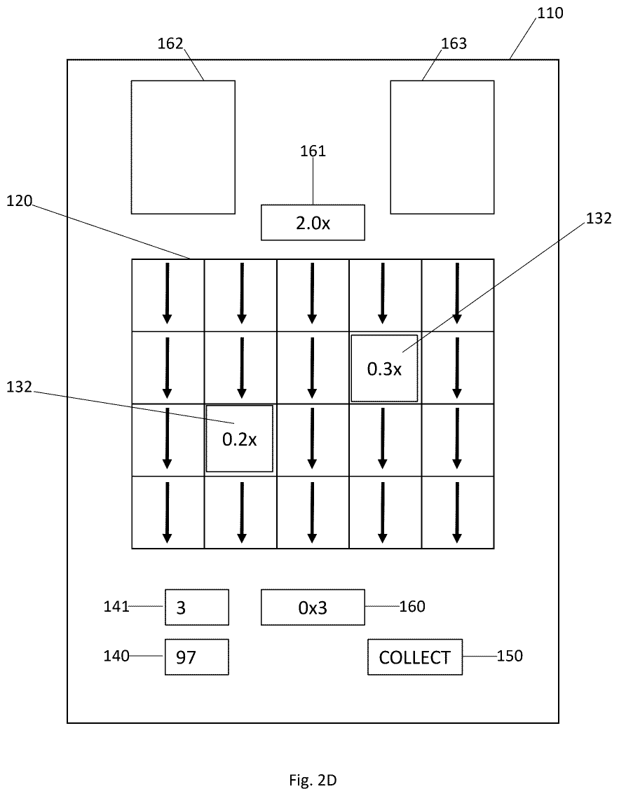

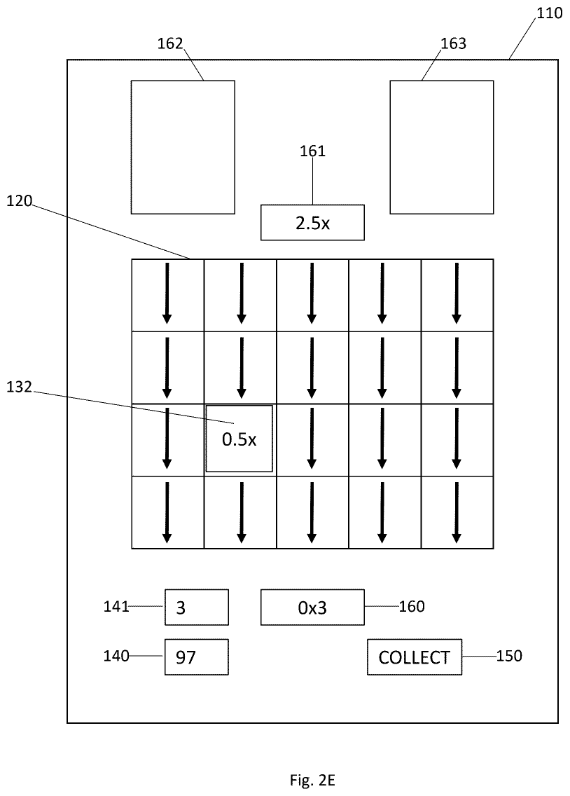

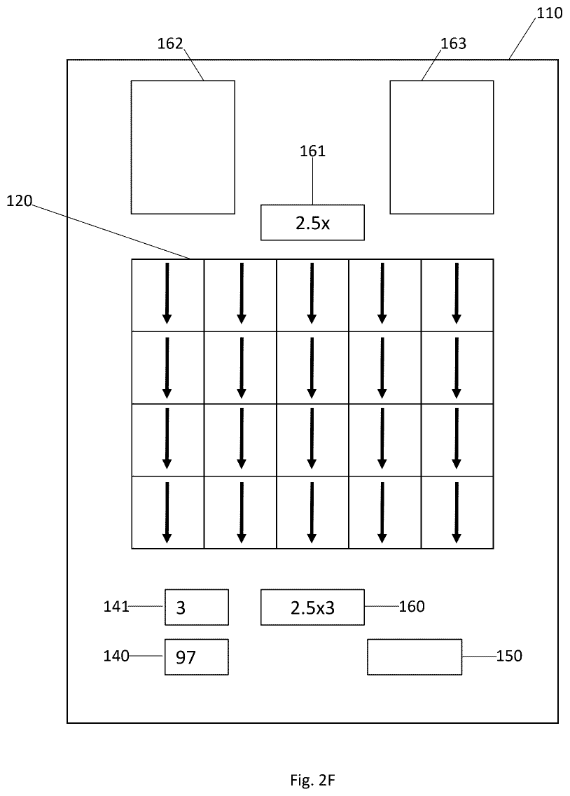

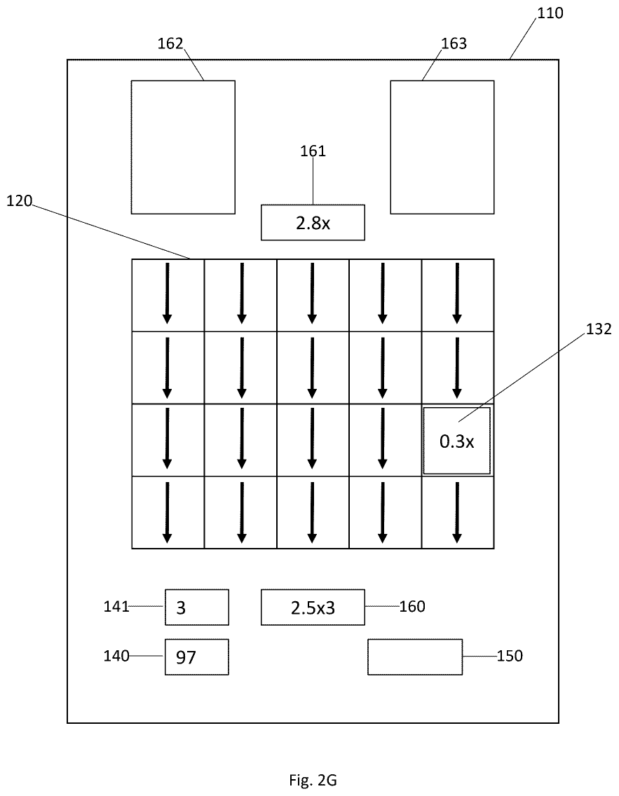

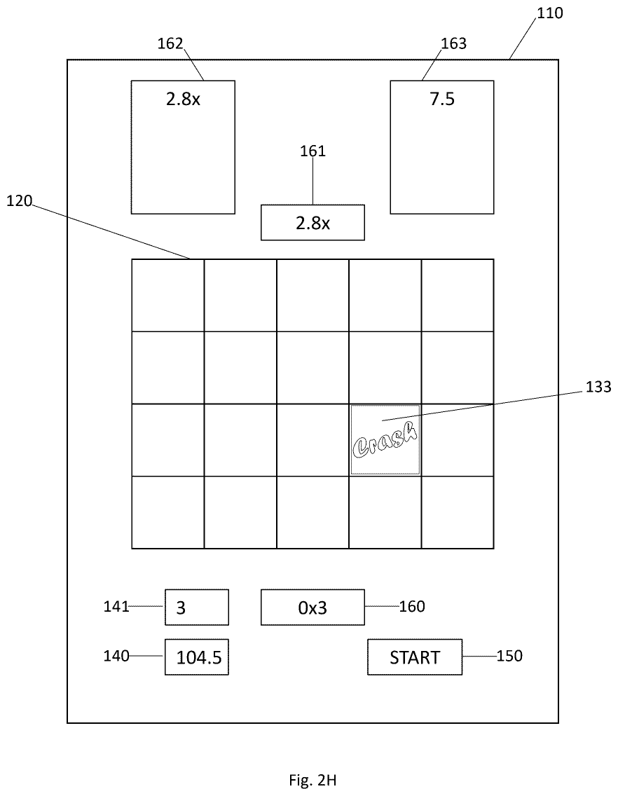

FIGS. 2A to 2H show schematic illustrations of examples of play of a game executed by the gaming device 100 already described in connection with FIGS. 1A to 1H.

FIG. 2A shows the graphical environment 110 after initiation of the play of the game by triggering the “START” button 150. The button 150 is deactivated and unlabelled so as to depict its deactivated status. The wager value of 3 credit points is deducted from the initial credit balance of 100 credit points. Therefore, the updated credit balance shown in the credit meter 140 is 97 credit points. In each intersection (or position) of the matrix of symbol positions 120, a reel strip is spinning, which is indicated by the arrows. The value of the award display 160 is set to the initial value of “0×3” (this is zero times the wager value of 3 credit points), and the value in the multiplier display 161 is initialized to be “1.0×”. The play of the game is in the first round (or first play) of the gaming session, which is why the history display 162 and the wins display 163 have no entries yet.

Referring to FIG. 2B, the reel strip in an intersection (or a position) of the matrix of symbol positions 120 has stopped and displays a multiplier symbol 132 that is assigned a multiplier value of “0.3×”. This value is added to a multiplier value memory and the accumulated multiplier value in the multiplier display 161 is updated to be “1.3×” (this is 1.0×+0.3×=1.3×). At this point of the play of the game, a collectable award (or win) amounts to 1.3 times the wager value of 3 credit points and therefore is 3.9 credit points (this is 1.3×3=3.9). For enabling a user (or player) to collect the award (or win), the button 150 is reactivated and has now the title “COLLECT”. Alternatively, an additional button titled “COLLECT” may be activated. After a pause, spinning of the stopped reel strip resumes. A length of the pause may depend on the assigned multiplier value of the displayed multiplier symbol. For example, the length of the pause may increase proportional to the assigned multiplier value. Pauses of stopped reel strips displaying a symbol that is not a multiplier symbol or the crash symbol may be so short that a user (or player) can barely perceive the stops of the reel strips and thus has the impression that the reel strips are continuously spinning.

In FIG. 2C, the same reel strip as in FIG. 2B has stopped. However, the stopped reel strip now displays a multiplier symbol 132 that is assigned a multiplier value of “0.2×”. This value is added to the multiplier value memory and the accumulated multiplier value in the multiplier display 161 is updated to be “1.5×” (this is 1.3×+0.2×=1.5×). Once again, spinning of the stopped reel strip resumes after a pause. The “COLLECT” button 150 is still active since the user (or player) has not collected the award (or win) yet.

In FIG. 2D, two stopped reel strips are shown. The first stopped reel strip displays a multiplier symbol 132 that is assigned a multiplier value of “0.3×” and the second stopped reel strip displays a multiplier symbol 132 that is assigned a multiplier value of “0.2×”. These multiplier values are added to the multiplier value memory and the accumulated multiplier value in the multiplier display 161 is updated to be “2.0×” (this is 1.5×+0.3×+0.2×=2.0×). Spinning of both stopped reel strips then resumes after a pause, wherein the length of the pause of the reel strip displaying the multiplier value of “0.3×” may be longer than the length of the pause of the reel strip displaying the multiplier value of “0.2×”. The “COLLECT” button 150 is still active since the user (or player) has not collected the award (or win) yet.

In FIG. 2E, again only one stopped reel strip is shown. The stopped reel strip displays a multiplier symbol 132 that is assigned a multiplier value of “0.5×”. This value is added to the multiplier value memory and the accumulated multiplier value in the multiplier display 161 is updated to be “2.5×” (this is 2.0×+0.5×=2.5×). Once again, spinning of the stopped reel strip resumes after a pause. The “COLLECT” button 150 is still active since the user (or player) has not collected the award (or win) yet.

In FIG. 2F, no stopped reel strip is shown. However, the “COLLECT” button 150 is deactivated and unlabelled so as to depict its deactivated status since the user (or player) has collected the award (or win) by triggering the “COLLECT” button 150. The award display 160 is set to “2.5×3” (this is 2.5 times the wager value of 3 credit points). Triggering the “COLLECT” button 150 stops the play of the game. In preferred embodiments, however, the play of the game may continue without changing the collected award (or win) until the crash symbol is displayed in the matrix of symbol positions. Such a preferred embodiment shows the user (or player) the maximum award (or win) that could have been collected and is depicted in the following FIGS. 2G to 2H.

In FIG. 2G, one stopped reel strip is shown. The stopped reel strip displays a multiplier symbol 132 that is assigned a multiplier value of “0.3×”. This value is added to the multiplier value memory together with a note that the value was added after the stop of play of the game. Alternatively, the value is added to a second multiplier value memory. Thus, the collected award (or win) is not changed and the value of the award display 160 remains unchanged at “2.5×3”. However, the accumulated multiplier value in the multiplier display 161 is updated to be “2.8×” (this is 2.5×+0.3×=2.8×). Once again, spinning of the stopped reel strip resumes after a pause. The button 150 is still deactivated since the user (or player) has already collected the award (or win).

In FIG. 2H, the crash symbol is displayed in the matrix of symbol positions and thus all reel strips have been stopped. The credit control circuitry of the processor arrangement may update the credit meter so that the collected award (or win) of 7.5 credit points (this is 2.5 times the wager value of 3 credit points) is added to the current credit balance of 97 credit points. This results in an updated credit balance of 104.5 credit points (this is 97+7.5=104.5). As shown in FIG. 2H, the processor arrangement causes the credit meter 140 to display the updated credit balance of 104.5 credit points and sets the value of the award display 160 to the initial value of “0×3” (this is zero times the wager value of 3 credit points). The accumulated multiplier value of “2.8×” and the value of the collected award (or win) of “7.5” are added to the history display 162 and the wins display 163, respectively. Furthermore, the button 150 is reactivated and has again the title “START” for initiating a new round (or play) of the game.

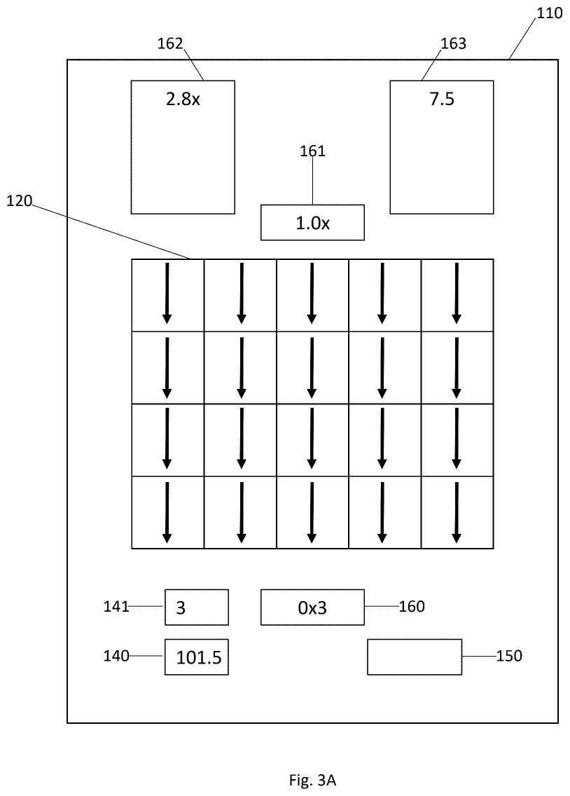

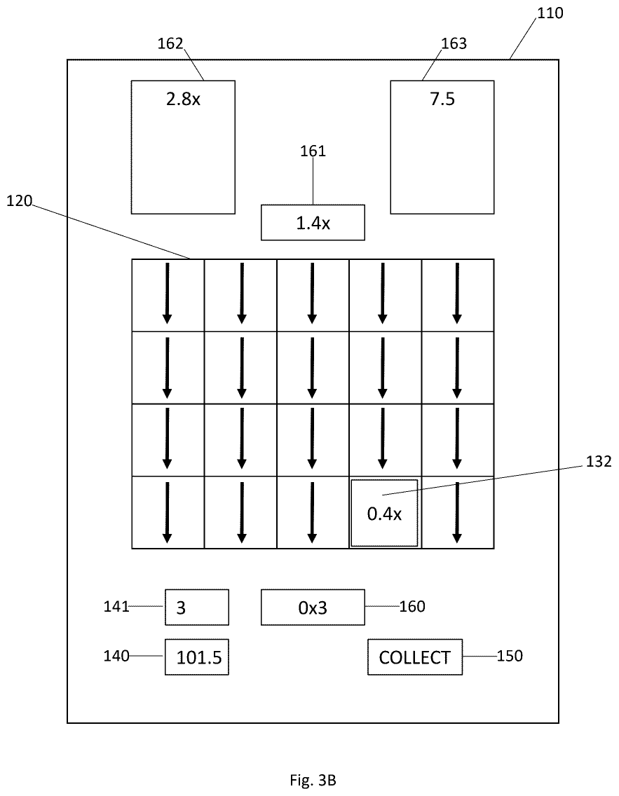

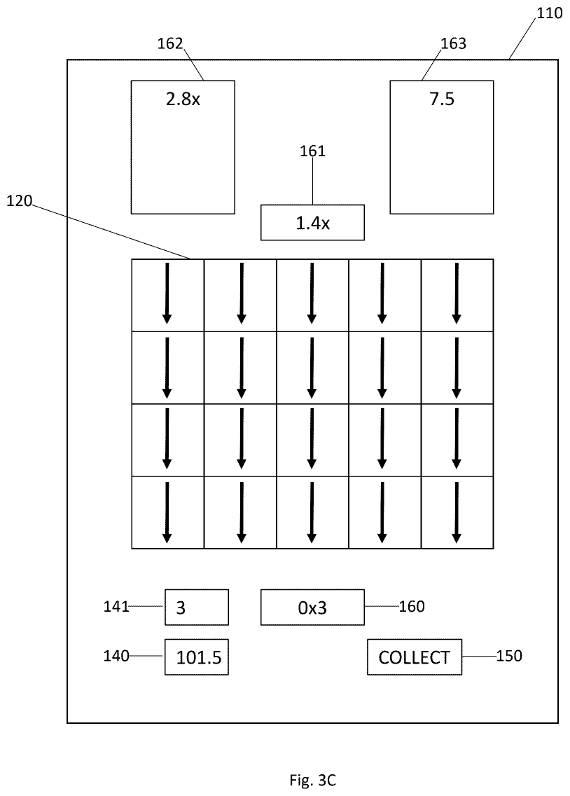

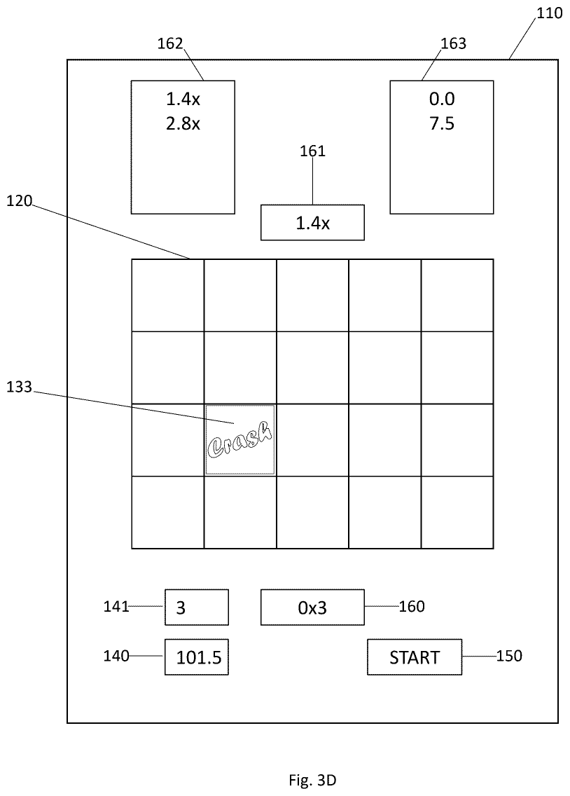

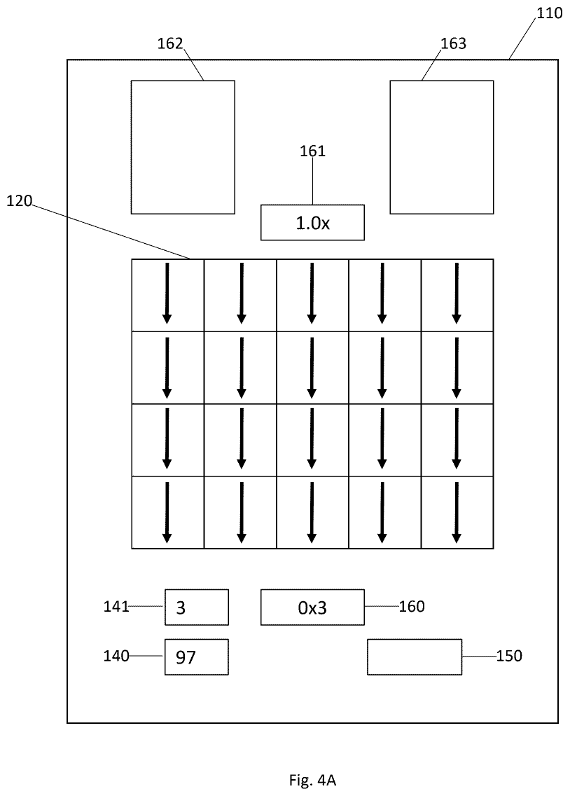

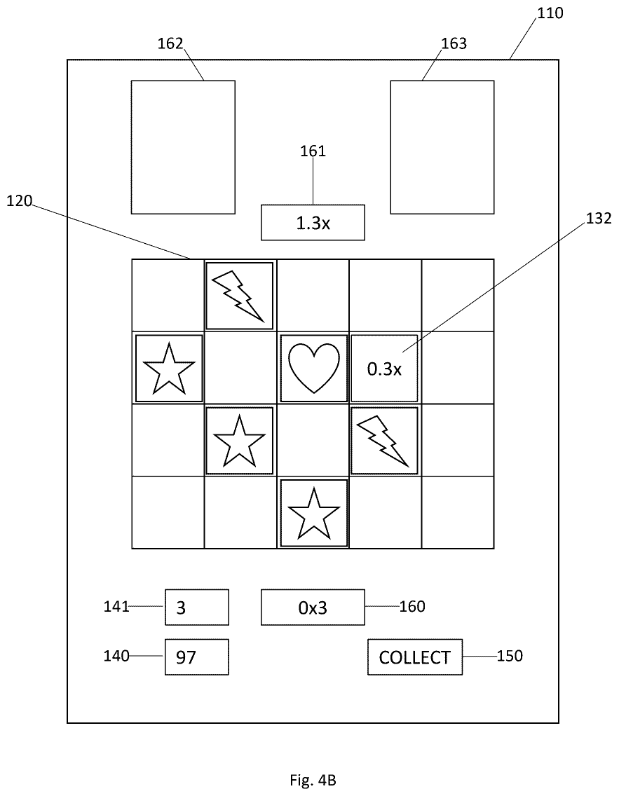

FIGS. 3A to 3D show schematic illustrations of further examples of play of a game executed by the gaming device 100 already described in connection with FIGS. 1A to 2H.

FIG. 3A shows the graphical environment 110 after initiation of another round (or play) of the game by triggering the “START” button 150. The button 150 is deactivated and unlabelled so as to depict its deactivated status. Since the user (or player) has not changed the wager value (or bet amount), the wager value of 3 credit points, which is displayed in the bet display 141, is deducted from the credit balance of 104.5 credit points. Therefore, the updated credit balance shown in the credit meter 140 is 101.5 credit points. In each intersection (or position) of the matrix of symbol positions 120, a reel strip is spinning, which is indicated by the arrows. The award display 160 displays the initial value of “0×3” (this is zero times the wager value of 3 credit points), and the value in the multiplier display 161 is initialized to be “1.0×”. The play of the game is in the second round (or second play) of the gaming session, which is why the history display 162 and the wins display 163 display the accumulated multiplier value of “2.8×” and the value of the collected award (or win) of 7.5 credit points of the first round (or first play), respectively. The initiation of the new round (or new play) of the game may further include the deletion of the multiplier values stored in the multiplier value memory during the preceding round (or preceding play) of the game. Alternatively, the multiplier values may be stored in the multiplier value memory together with a note indicating the round (or play) of the game to which the multiplier value belongs. Both alternatives allow to determine both the accumulated multiplier value and the award (or win) from the multiplier values stored in the multiplier value memory for the current round (or current play) of the game. However, only the latter alternative allows to determine in retrospect both the accumulated multiplier value and the award (or win) from the multiplier values stored in the multiplier value memory for all rounds (or all plays) of the game played during a gaming session and may be used to update the history display 162 and the wins display 163.

Referring to FIG. 3B, the reel strip in an intersection (or a position) of the matrix of symbol positions 120 has stopped and displays a multiplier symbol 132 that is assigned a multiplier value of “0.4×”. This value is added to the multiplier value memory and the accumulated multiplier value in the multiplier display 161 is updated to be “1.4×” (this is 1.0×+0.4×=1.4×). At this point of the play of the game, a collectable award (or win) amounts to 1.4 times the wager value of 3 credit points and therefore is 4.2 credit points (this is 1.4×3=4.2). For enabling a user (or player) to collect the award (or win), the button 150 is reactivated and has now the title “COLLECT”. Alternatively, an additional button titled “COLLECT” may be activated. After a pause, spinning of the stopped reel strip resumes.

In FIG. 3C, no stopped reel strip is shown. The “COLLECT” button 150 is still active since the user (or player) has not collected the award (or win) yet.

In FIG. 3D, the crash symbol is displayed in the matrix of symbol positions and thus all reel strips have been stopped. Since the user (or player) had not triggered the “COLLECT” button 150 before the crash symbol was displayed in the matrix of symbol positions, no award (or win) has been collected. Therefore, the outcome of this round (or play) of the game is 0.0 and this value is added to the wins display 163. The accumulated multiplier value of “1.4×” is added to the history display 162. Whereas the value of the award display 160 is set to the initial value of “0×3” (this is zero times the wager value of 3 credit points), the credit balance shown in the credit meter 140 remains unchanged at 101.5 credit points since no credit value is credited to the user's (or player's) credit balance. The button 150 is still active but has now the title “START” so as to indicate that a new round (or new play) of the game can be started and initiated by triggering the “START” button 150.

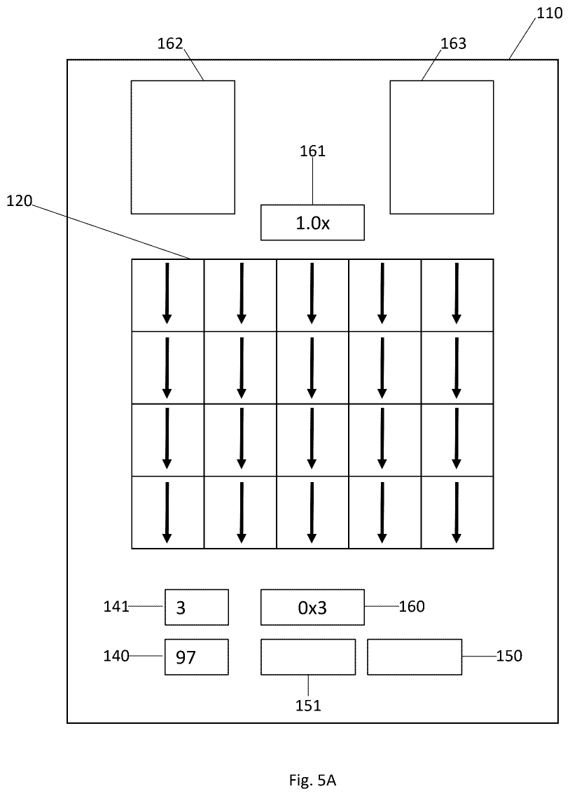

FIGS. 4A and 4B show schematic illustrations of examples of play of a game executed by the gaming device 100 already described in connection with FIGS. 1A to 1H.

FIG. 4A shows the graphical environment 110 after initiation of the play of the game by triggering the “START” button 150. The button 150 is deactivated and unlabelled so as to depict its deactivated status. The wager value of 3 credit points is deducted from the initial credit balance of 100 credit points. Therefore, the updated credit balance shown in the credit meter 140 is 97 credit points. In each intersection (or position) of the matrix of symbol positions 120, a reel strip is spinning, which is indicated by the arrows. The value of the award display 160 is set to the initial value of “0×3” (this is zero times the wager value of 3 credit points), and the value in the multiplier display 161 is initialized to be “1.0×”. The play of the game is in the first round (or first play) of the gaming session, which is why the history display 162 and the wins display 163 have no entries yet.

Referring to FIG. 4B, all reel strips in the intersections (or positions) of the matrix of symbol positions 120 have stopped simultaneously. In an intersection (or a position), a stopped reel strip may display a symbol of the plurality of symbols or an empty space, as is depicted in FIG. 4B. In one intersection (or position), a reel strip displays a multiplier symbol 132 that is assigned a multiplier value of “0.3×”. This value is added to a multiplier value memory and the accumulated multiplier value in the multiplier display 161 is updated to be “1.3×” (this is 1.0×+0.3×=1.3×). At this point of the play of the game, a collectable award (or win) amounts to 1.3 times the wager value of 3 credit points and therefore is 3.9 credit points (this is 1.3×3=3.9). For enabling a user (or player) to collect the award (or win), the button 150 is reactivated and has now the title “COLLECT”. Alternatively, an additional button titled “COLLECT” may be activated. After a pause, all reel strips simultaneously resume spinning. A length of the pause may depend on the circumstance whether or not a multiplier symbol is displayed and the assigned multiplier value of the displayed multiplier symbol. For example, the length of the pause may increase proportional to the assigned multiplier value. If no multiplier symbol is displayed, the pause may be so short that a user (or player) can barely perceive the simultaneous stop of the reel strips and thus has the impression that the reel strips are continuously spinning.

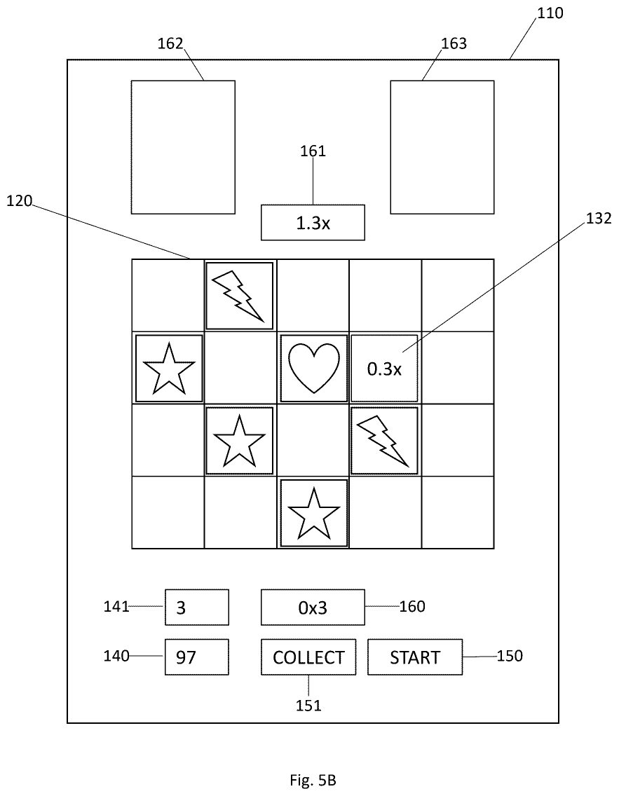

FIGS. 5A and 5B show schematic illustrations of examples of play of a game executed by the gaming device 100 already described in connection with FIGS. 1A to 1H.

In this example, the graphical environment 110 comprises an additional button 151 for collecting an award (or win).

FIG. 5A shows the graphical environment 110 after initiation of the play of the game by triggering the “START” button 150. The button 150 and the button 151 are deactivated and unlabelled so as to depict their deactivated status. The wager value of 3 credit points is deducted from the initial credit balance of 100 credit points. Therefore, the updated credit balance shown in the credit meter 140 is 97 credit points. In each intersection (or position) of the matrix of symbol positions 120, a reel strip is spinning, which is indicated by the arrows. The value of the award display 160 is set to the initial value of “0×3” (this is zero times the wager value of 3 credit points), and the value in the multiplier display 161 is initialized to be “1.0×”. The play of the game is in the first round (or first play) of the gaming session, which is why the history display 162 and the wins display 163 have no entries yet.

Referring to FIG. 5B, all reel strips in the intersections (or positions) of the matrix of symbol positions 120 have stopped simultaneously. In an intersection (or a position), a stopped reel strip may display a symbol of the plurality of symbols or an empty space, as is depicted in FIG. 5B. In one intersection (or position), a reel strip displays a multiplier symbol 132 that is assigned a multiplier value of “0.3×”. This value is added to a multiplier value memory and the accumulated multiplier value in the multiplier display 161 is updated to be “1.3×” (this is 1.0×+0.3×=1.3×). At this point of the play of the game, a collectable award (or win) amounts to 1.3 times the wager value of 3 credit points and therefore is 3.9 credit points (this is 1.3×3=3.9). For enabling a user (or player) to collect the award (or win), the button 151 is activated and has the title “COLLECT”. Furthermore, the “START” button 150 is reactivated. The user (or player) has now the choice to collect the award (or win) by triggering the “COLLECT” button 151, thereby ending the current round (or current play) of the game, or to trigger the “START” button 150. After triggering the “START” button 150, all reel strips simultaneously resume spinning and play of the current round of the game continues until the next simultaneous stop of all reel strips.

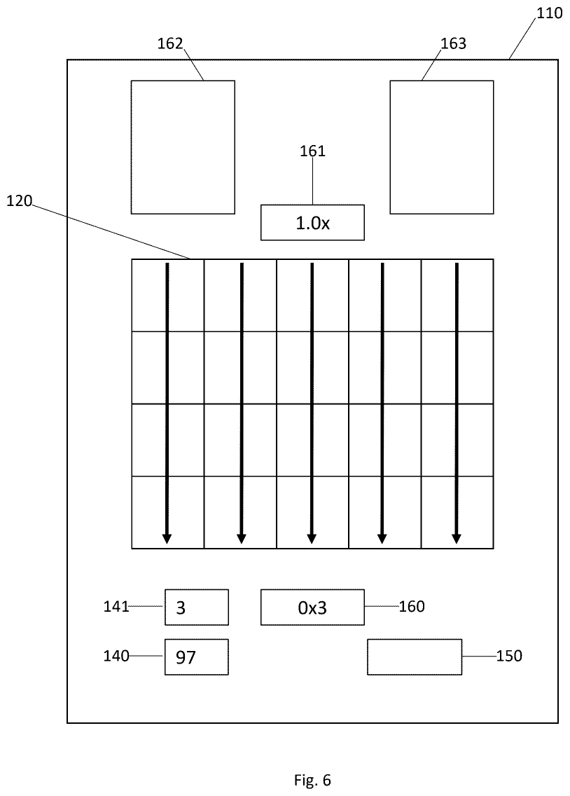

FIG. 6 shows schematic illustrations of examples of play of a game executed by the gaming device 100 already described in connection with FIGS. 1A to 1H.

FIG. 6 shows the graphical environment 110 after initiation of the play of the game by triggering the “START” button 150. The button 150 is deactivated and unlabelled so as to depict its deactivated status. The wager value of 3 credit points is deducted from the initial credit balance of 100 credit points. Therefore, the updated credit balance shown in the credit meter 140 is 97 credit points. In each column of the matrix of symbol positions 120, a reel strip is spinning, which is indicated by the arrows. Four consecutive symbol positions of the stopped reel strip are always aligned with the four intersections (or positions) of the column to which the reel strip is assigned. The value of the award display 160 is set to the initial value of “0×3” (this is zero times the wager value of 3 credit points), and the value in the multiplier display 161 is initialized to be “1.0×”. The play of the game is in the first round (or first play) of the gaming session, which is why the history display 162 and the wins display 163 have no entries yet.

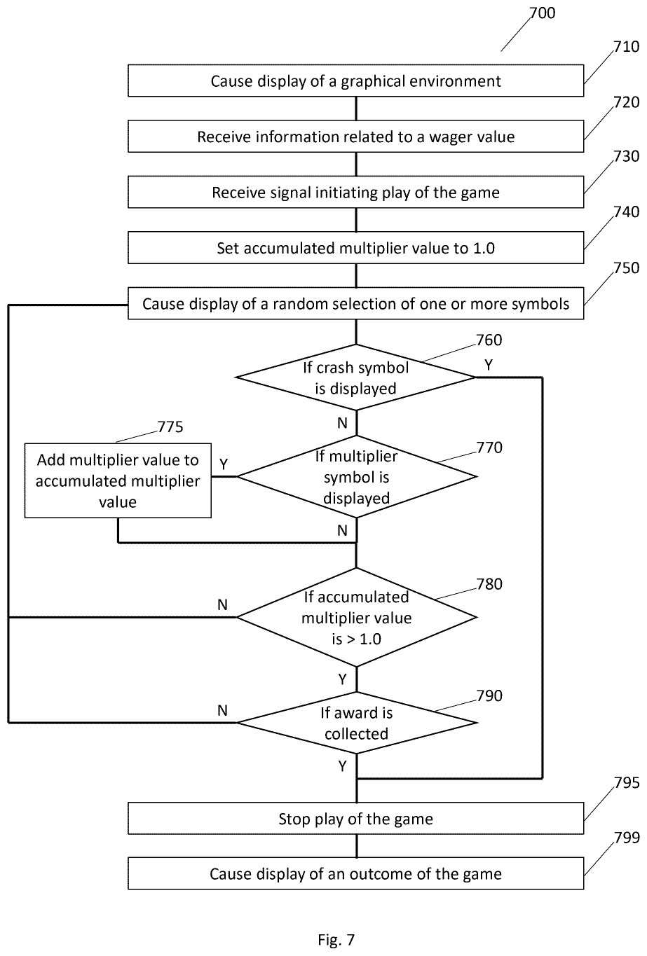

FIG. 7 shows a flow chart of a method 700 of operating the gaming device. The method 700 may include one or more or all of the features of the gaming device and the play of the game already described in connection with FIGS. 1A to 6.

The method comprises 710 causing display of a graphical environment on a display device or unit. The graphical environment comprises a matrix of symbol positions for displaying a plurality of symbols, wherein the matrix of symbol positions is formed by intersections of at least one row intersecting a plurality of columns or at least one column intersecting a plurality of rows. The plurality of symbols comprises a crash symbol and at least one multiplier symbol that is assigned a multiplier value.

The method further comprises 720 receiving information related to a wager value for play of a game. The information related to the wager value may be generated by a user (or player) using a user input interface.

The method further comprises 730 receiving a signal initiating play of the game. The signal initiating play of the game may be generated by a user (or player) triggering a play or “START” button present in the graphical environment.

The method further comprises 740 setting an accumulated multiplier value to an initial value of 1.0.

The method further comprises 750 causing display of a random selection of one or more symbols of the plurality of symbols in the matrix of symbol positions.

Then the method comprises determining 760 if the crash symbol is displayed in the matrix of symbol positions formed by the displayed random selection of one or more symbols. If the crash symbol is displayed, 795 play of the game is stopped. Otherwise, the method comprises determining 770 if the at least one multiplier symbol is displayed in the matrix of symbol positions formed by the displayed random selection of one or more symbols. If the at least one multiplier symbol is displayed, the method comprises 775 adding the assigned multiplier value of the at least one multiplier symbol to the accumulated multiplier value. If more than one multiplier symbol is displayed in the matrix of symbol positions formed by the displayed random selection of one or more symbols, the assigned multiplier values of all displayed multiplier symbols are added to the accumulated multiplier value.

Then the method further comprises determining 780 if the accumulated multiplier value is greater than 1.0. If the accumulated multiplier value is greater than 1.0, the method comprises determining 790 if a collect signal is received. A collect signal may be generated by a user (or player) triggering a “COLLECT” button present in the graphical environment so as to collect an outcome of the game (or game outcome or award or win). If a collect signal is received, 795 play of the game is stopped.

If the accumulated multiplier value is not greater than 1.0 or no collect signal is received, the method returns to the step 750 causing display of a new random selection of one or more symbols of the plurality of symbols in the matrix of symbol positions, which then is being processed as previously described.

After 795 stopping play of the game, the method further comprises 799 causing display of an outcome of the game.

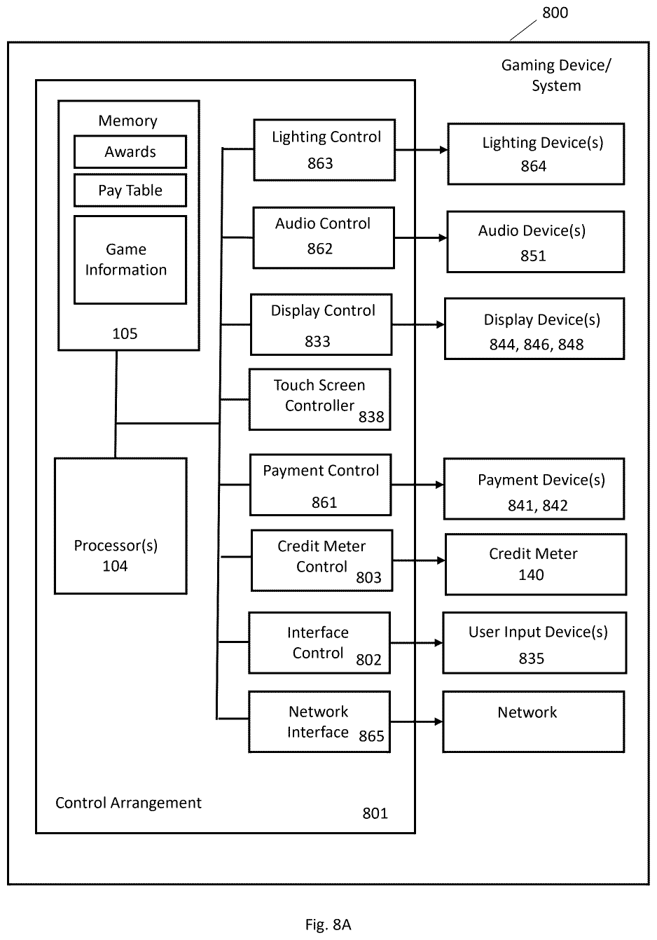

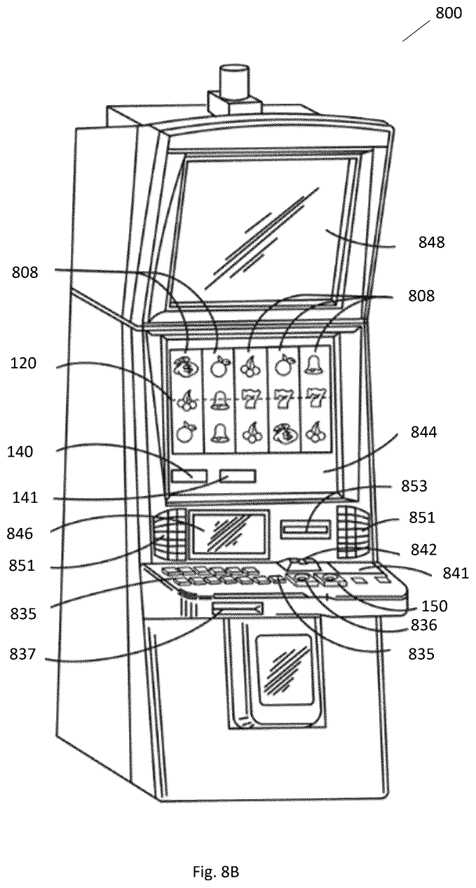

FIGS. 8A and 8B show schematic illustrations of a gaming system 800 according to various embodiments. The gaming system 800 may include or may be a gaming device (shown in FIG. 8B). The gaming device 800 may include one or more or all of the features of the gaming device and the play of the game already described in connection with FIGS. 1A to 7.

The gaming device 800 may include game control circuitry 801, which may include the processor arrangement 104 of at least one processor 104. The control arrangement 801 may further include interface control circuitry 802, credit meter control circuitry 803 coupled to a credit meter 140, and memory arrangement 105.

The control arrangement 801 may further include payment control circuitry 861 in communication with at least one payment device 841 of the gaming system or gaming device. The payment control circuitry 801 may be in communication with the processor arrangement 104. The payment device 841 may accept a physical item associated with a monetary value and may establish or increase a credit balance for the user (or player) based on the monetary value. The payment device may be a payment acceptor 841 including a note, ticket, card, and/or bill acceptor wherein the user (or player) inserts paper money, a ticket, or voucher, and/or a coin slot 842 where the user (or player) inserts money, coins, or tokens. Payment devices such as readers or validators for credit cards, debit cards, and/or credit slips may accept payment. A user (or player) may insert an identification card into a card reader of gaming device 800. The identification card may be a smart card having a programmed microchip, a coded magnetic strip, or a coded rewritable magnetic strip, wherein the programmed microchip or magnetic strips are coded with a user's (or player's) identification, credit totals (or related data), and/or other relevant information.

Optionally, a user (or player) may carry a portable device, such as a cell phone, a radio frequency identification tag, or any other suitable wireless device, which communicates a user's (or player's) identification, credit totals (or related data), and other relevant information to the gaming device 800. Money (or credit) may be transferred to the gaming device 800 through electronic funds transfer. It may be appreciated that if a user (or player) funds the gaming device 800, the control arrangement may include payment control circuitry for determining the amount of funds entered and displays the corresponding amount on the credit or other suitable display as described previously.

The gaming device 800 may include at least one input device 835 in communication with the control arrangement 801. Input device(s) 835 may include any suitable device that enables the user (or player) to produce an input signal that is received by the control arrangement 801. An input device 835 may be a wager input device, such as a wager button. The user (or player) may place a bet by pushing the wager button. A wager button may be a bet one button, which by selecting, the user (or player) may wager one credit (i.e., a number of credit points, dollars, cents, etc.). The user (or player) may increase the bet by one credit each time the user (or player) pushes the bet one button. In response to the user (or player) pushing the bet one button, the number of credits shown in the credit display may decrease by one, and the number of credits shown in the bet display may increase by one. Optionally, an input device 835, such as a wager button, may be a bet max button, which may enable the user (or player) to bet the maximum wager. Optionally, an input device 835 may be one or more intermediate wager buttons, which may allow a user (or player) to bet one or more intermediate wagers that are permitted or accepted for a game of gaming device 800. An input device may be a cash-out button 836. The user (or player) may push the cash-out button 836 and initiate a “cash-out” operation to receive a cash payment or other suitable form of payment corresponding to the number of remaining credits. Optionally, in response to the user (or player) cashing out, a payment device, such as a ticket, payment, or note generator 837 prints or otherwise generates a ticket or credit slip to provide to the user (or player). The user (or player) receives the ticket or credit slip and may redeem the value associated with the ticket or credit slip via a cashier (or another suitable redemption system). Optionally, in response to the user (or player) cashing out, the user (or player) may receive the coins or tokens in a coin payout tray. Optionally, an input device may be a game activation device (e.g., a play or “START” button 150), which is used by the user (or player) to start the selected game or sequence of events in the gaming device 800. The play button can be any suitable play activator such as a bet one button, a max bet button, or a repeat the bet button. Optionally, upon appropriate funding, a gaming device 800 may begin the gameplay of a selected game automatically. Optionally, upon the user (or player) engaging one of the play buttons, a gaming device 800 automatically activates gameplay. Optionally, a gaming device 800 may include one or more game selection devices, such as one or more game selection buttons and/or one or more pull arms, which may be used by the user (or player) to select and/or start a game or sequence of events on the gaming device 800.

Additionally or optionally, the gaming device 800 may include at least one card reader 853 in communication with the at least one processor 104 of the processor arrangement 104. In this embodiment, a user (or player) is issued a player identification card, which has an encoded user (or player) identification number that uniquely identifies the user (or player). In response to a user (or player) inserting their user (or player) tracking card into the card reader to begin a gaming session, the card reader reads the user (or player) identification number of the user (or player) tracking card to identify the user (or player). It should be appreciated that any suitable payout mechanism, such as funding to the user's (or player's) electronically recordable identification card or smart card, may be implemented in accordance with gaming device 800.

An input device may be a touch-screen display coupled with a touch-screen controller 838 or some other touch-sensitive display overlay to allow for user (or player) interaction with the images on a display 106. Optionally, the gaming device 800 may include (e.g., a central display 844, upper display 848, and/or user (or player) tracking display 846). The touch-screen display and/or touch-screen controller 838 may be coupled to the video or display controller 833. A user (or player) may make decisions and input signals into gaming device 800 by touching the touch-screen at the appropriate locations.

The gaming device 800 may have a support structure, housing, or cabinet, which provides support for a plurality of displays, inputs, controls, and other features of an electronic gaming machine (EGM). Gaming device 800 may be positioned on a base or stand or can be configured as a pub-style tabletop game (not shown), which a user (or player) can operate preferably while sitting. It should be appreciated that gaming device 800 may have varying cabinet and display configurations. Optionally, the displays may be preferably connected to or mounted on the cabinet of the gaming device 800. The displays may also serve as digital glass operable to advertise games or other aspects of the gaming establishment. Optionally, the game control circuitry including the at least one processor and/or memory device including game information may reside within the cabinet of the gaming device.

One or more displays of the gaming device may be configured to display a credit balance, which displays a user's (or player's) current number of credits, cash, account balance, or the equivalent. Additionally or optionally, the gaming device 800 may include a bet display 141, which displays a user's (or player's) amount wagered. Additionally or optionally, the gaming device 800 may further include a user (or player) tracking display 846, which displays information regarding a user's (or player's) play tracking status. It should be appreciated that these devices are in communication with the processor 104. The at least one display may be a mobile display device, such as a PDA or tablet PC, that enables play of at least a portion of a game at a location remote from gaming device 800.

The displays 848, 844, 846 may include, without limitation, a monitor, a television display, a plasma display, a liquid crystal display (LCD), a display based on light-emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. Optionally, as described in more detail below, the display includes a touch-screen with an associated touch-screen controller. The displays may be of any suitable size and configuration, such as a square, rectangle, elongated rectangle, oval, etc. The displays 844, 846, 848 of gaming device 800 may be configured to display at least one game and associated images, symbols, and indicia such as any visual representation or exhibition of the movement of objects such as mechanical, virtual, or video reels and wheels, etc., and the like. Optionally, central display 844, upper display 848, and/or user (or player) tracking display 846 may be divided into one or more screens or sub-displays, to display one or more games, symbols, graphics, or other images/information. Optionally, the symbols, images, and indicia displayed on or of display(s) may be in mechanical form. That is, the display may include any electromechanical device, such as one or more mechanical objects, such as one or more rotatable wheels or reels 808 configured to display at least one or a plurality of games or other suitable images, symbols, or indicia.

The gaming device 800 may further include audio control circuitry 862. At least one sound-generating device (e.g. audio device 851) may be controlled by one or more sound cards of the audio control circuitry 862. The audio control circuitry 862 may be coupled to and may function in conjunction with the at least one processor 104 and/or gaming control circuitry. Optionally, the sound-generating device may include at least one speaker 851 (e.g., speakers 851 of the gaming device) or other hardware and/or software for generating sounds, such as by playing music for a game(s), or by playing music for other modes of gaming device 800, such as an attract mode. The gaming device 800 may further include lighting control circuitry 863, which may be coupled to one or more lighting devices 864. The gaming device 800 may provide dynamic sounds coupled with attractive multimedia images displayed on one or more of the displays 848, 844, 846 to provide an audio-visual representation or to otherwise display full-motion video with sound to attract users (or players) to the gaming device 800. During idle periods, gaming device 800 may display a sequence of audio and/or visual attraction messages to attract potential users (or players) to the gaming device 800. The videos may also be customized to provide any appropriate information.

The gaming device 800 may further include a network interface control circuitry 865, which may connect the gaming device 800 to one, or more external devices via a communication network (e.g. a wired or wireless). The gaming device 800 may further include a plurality of communication ports for enabling communication of the processor with external peripherals, such as external video sources, expansion buses, game or other displays, a SCSI port, or a keypad.

Gaming device 800 may incorporate any suitable wagering game(s). Gaming device 800 may include some or all of the features of conventional gaming machines or devices (e.g., slot machines). A game(s) on the gaming device 800 may be any suitable reel-type game susceptible to representation in an electronic or electromechanical form, which may produce a random outcome based on pay-out probability data at the time of or after placement of a wager. Alternatively, game(s) may be a video poker game, a video bingo or keno game, a Class II game displayed using Class III visual elements (e.g., a video slot game that uses a bingo-based ball call), or any other suitable game.

Optionally, in addition to winning credits or other awards in a game on the gaming device 800, the gaming device may also give users (or players) the opportunity to win credits in a bonus or a secondary round of a game. The bonus or secondary round enables the user (or player) to obtain a prize or payout in addition to the prize or payout, if any, obtained from the base or primary round of the game. In general, a bonus or secondary round produces a significantly higher level of user (or player) excitement than the base or primary round of the game because it provides a greater expectation of winning than the base or primary round, and is accompanied by more attractive or unusual features than the base or primary round. It should be appreciated that, in one embodiment, the bonus or secondary round is similar to the base or primary round.

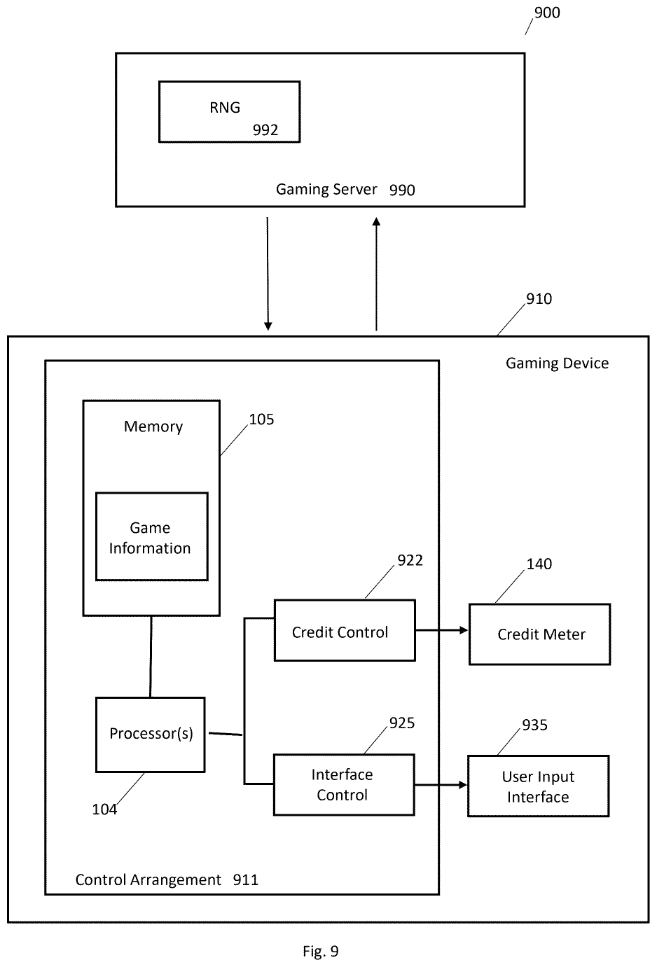

FIG. 9 shows schematic illustrations of a system or a gaming system 900 according to various embodiments. The gaming system 900 includes one or more or all of the features of the gaming device and the play of the game already described in connection with FIGS. 1A to 8B.

Referring to FIG. 9, the gaming system 900 may comprise a computer program or gaming device 910 comprising a computer-readable storage medium and a gaming server 990 comprising a random number generator 992 for generating the random selections of one or more symbols of the plurality of symbols.

The gaming server 990 may receive information related to the wager value from a gaming device 910 and/or a signal initiating play of the game. In response, the gaming server 990 may send animation information to the gaming device 910, wherein the animation information identifies animations for the display of random selections of one or more symbols of the plurality of symbols in the matrix of symbol positions by the gaming device 910. The animation information may comprise the information about which reel strip to stop when, and in which position of its rotation or the equivalent information about which symbol to display when, and in which intersection (or position) of the matrix of symbol positions.

The gaming device 910 may comprise a processor arrangement 104 comprising at least one processor, and a memory arrangement 105 for storing a plurality of instructions, which when executed by the processor arrangement 104, causes the processor arrangement 104 to:
(a) cause display of a graphical environment on a display device, wherein the graphical environment comprises a matrix of symbol positions for displaying a plurality of symbols;
(b) receive information related to a wager value for play of a game;
(c) receive a signal initiating play of the game and send the information related to the wager value and/or the signal initiating play of the game to the gaming server;
(d) receive information regarding random selections of one or more symbols of the plurality of symbols from the gaming server and cause display of the random selections of one or more symbols of the plurality of symbols in the matrix of symbol positions, wherein the plurality of symbols comprises a crash symbol and at least one multiplier symbol that is assigned a multiplier value;
(e) add the assigned multiplier value of the at least one multiplier symbol to a multiplier value memory if the at least one multiplier symbol is displayed in the matrix of symbol positions;
(f) stop play of the game if the crash symbol is displayed in the matrix of symbol positions or if a collect signal is received;
(g) cause display of an outcome of the game.

The gaming device 910 may include game control circuitry 911, which may include the processor arrangement 104 of at least one processor 104. The control arrangement 911 may further include interface control circuitry 925 in communication with a user input interface 935, credit control circuitry 922 coupled to a credit meter 140, and memory arrangement 105.

The following examples pertain to further embodiments, from which numerous permutations and configurations will be apparent, and whose scope of subject matter is defined by the appended claims.

An example (e.g. example 1) relates to a device or a gaming device comprising a display device, a processor arrangement comprising at least one processor, and a memory arrangement for storing a plurality of instructions. The instructions, when executed by the processor arrangement, cause the processor arrangement to cause the display device to display a graphical environment comprising a matrix of symbol positions for displaying a plurality of symbols. The matrix of symbol positions is formed by intersections of at least one row intersecting a plurality of columns or at least one column intersecting a plurality of rows. The plurality of symbols comprises a crash symbol and at least one multiplier symbol that is assigned a multiplier value. The instructions further cause the processor arrangement to receive information related to a wager value for play of a game. The instructions further cause the processor arrangement to receive a signal initiating play of the game and to set a value of a multiplier value memory to an initial value. The instructions further cause the processor arrangement to cause display of a random selection of one or more symbols of the plurality of symbols in the matrix of symbol positions. The instructions further cause the processor arrangement to stop play of the game if the random selection of one or more symbols contains the crash symbol. If the random selection of one or more symbols does not contain the crash symbol but contains the at least one multiplier symbol, the instructions further cause the processor arrangement to add the assigned multiplier value of the at least one multiplier symbol to the value of the multiplier value memory. If the value of the multiplier value memory is greater than the initial value and a collect signal is received, the instructions cause the processor arrangement to stop play of the game. If play of the game is not stopped, the instructions cause the processor arrangement to cause display of a new random selection of one or more symbols of the plurality of symbols in the matrix of symbol positions and to process the new random selection of one or more symbols like the random selection of one or more symbols. If play of the game is stopped, the instructions cause the processor arrangement to cause display of an outcome of the game.

Another example (e.g. example 2) relates to a previously described example (e.g. example 1) or any of the examples described herein and may further include that causing display of the new random selection of one or more symbols of the plurality of symbols in the matrix of symbol positions requires a preceding receipt of a resume signal.

Another example (e.g. example 3) relates to a previously described example (e.g. example 2) or any of the examples described herein and may further include that the resume signal is generated by a user (or player) triggering a button so as to resume play of the game.

Another example (e.g. example 4) relates to a previously described example (e.g. one of the examples 1 to 3) or any of the examples described herein and may further include that the collect signal is generated by a user (or player) triggering a button so as to collect the outcome of the game (or game outcome or award or win).

Another example (e.g. example 5) relates to a previously described example (e.g. one of the examples 1 to 4) or any of the examples described herein and may further include that causing display of the random selection of one or more symbols of the plurality of symbols or the new random selection of one or more symbols of the plurality of symbols in the matrix of symbol positions comprises spinning reel strips comprising symbols of the plurality of symbols and randomly stopping the reel strips so as to display symbols of the reel strips in intersections (or positions) of the matrix of symbol positions.

Another example (e.g. example 6) relates to a previously described example (e.g. example 5) or any of the examples described herein and may further include that all spinning reel strips are stopped if the crash symbol is displayed in a position of the matrix of symbol positions.

Another example (e.g. example 7) relates to a previously described example (e.g. example 5 or 6) or any of the examples described herein and may further include that the spinning of a stopped reel strip resumes if the crash symbol is not displayed in a position of the matrix of symbol positions.

Another example (e.g. example 8) relates to a previously described example (e.g. example 7) or any of the examples described herein and may further include that the spinning of the stopped reel strip resumes after a pause if the stopped reel strip displays the at least one multiplier symbol.

Another example (e.g. example 9) relates to a previously described example (e.g. one of the examples 5 to 8) or any of the examples described herein and may further include that spinning of all reel strips is simultaneously stopped and resumed.

Another example (e.g. example 10) relates to a previously described example (e.g. one of the examples 1 to 9) or any of the examples described herein and may further include that the processor arrangement is configured to receive, via interface control circuitry in communication with a user input interface, the information related to the wager value and the signal initiating play of the game, wherein the processor arrangement causes display of the random selection of one or more symbols of the plurality of symbols in the graphical environment based on the signal initiating play of the game.

Another example (e.g. example 11) relates to a previously described example (e.g. one of the examples 1 to 10) or any of the examples described herein and may further include that the processor arrangement is configured to transmit the information related to the wager value and/or the signal initiating play of the game to a gaming server and to receive information regarding random selections of one or more symbols of the plurality of symbols from the gaming server.

Another example (e.g. example 12) relates to a previously described example (e.g. example 11) or any of the examples described herein and may further include that the information regarding random selections of one or more symbols of the plurality of symbols comprises information about which reel strip to stop when and in which position of its rotation or information about which symbol to display when and in which intersection (or position) of the matrix of symbol positions.

Another example (e.g. example 13) relates to a previously described example (e.g. one of the examples 1 to 12) or any of the examples described herein and may further include that the outcome of the game is based on the value of the multiplier value memory and the wager value.

Another example (e.g. example 14) relates to a previously described example (e.g. one of the examples 1 to 13) or any of the examples described herein and may further include that the value of the multiplier value memory is based on a summation of multiplier values assigned to multiplier symbols that are displayed in the matrix of symbol positions.

Another example (e.g. example 15) relates to a previously described example (e.g. one of the examples 1 to 14) or any of the examples described herein and may further include that the processor arrangement is configured to cause an update of a credit meter based on the outcome of the game.

An example (e.g. example 16) relates to a method of operating a gaming device, the method comprising causing display of a graphical environment on a display device, wherein the graphical environment comprises a matrix of symbol positions for displaying a plurality of symbols. The matrix of symbol positions is formed by intersections of at least one row intersecting a plurality of columns or at least one column intersecting a plurality of rows. The plurality of symbols comprises a crash symbol and at least one multiplier symbol that is assigned a multiplier value. The method further comprises receiving information related to a wager value for play of a game. The method further comprises receiving a signal initiating play of the game and setting a value of a multiplier value memory to an initial value. The method further comprises causing display of a random selection of one or more symbols of the plurality of symbols in the matrix of symbol positions. The method further comprises stopping play of the game if the random selection of one or more symbols contains the crash symbol. If the random selection of one or more symbols does not contain the crash symbol but contains the at least one multiplier symbol, the method further comprises adding the assigned multiplier value of the at least one multiplier symbol to the value of the multiplier value memory. If the value of the multiplier value memory is greater than the initial value and a collect signal is received, the method further comprises stopping play of the game. If play of the game is not stopped, the method further comprises causing display of a new random selection of one or more symbols of the plurality of symbols in the matrix of symbol positions and processing the new random selection of one or more symbols like the random selection of one or more symbols. The method further comprises causing display of an outcome of the game after the game is stopped.

Another example (e.g. example 17) relates to a previously described example (e.g. example 16) or any of the examples described herein and may further include that receiving a resume signal is required for causing display of the new random selection of one or more symbols of the plurality of symbols in the matrix of symbol positions.

Another example (e.g. example 18) relates to a previously described example (e.g. example 17) or any of the examples described herein and may further include that the resume signal is generated by a user (or player) triggering a button so as to resume play of the game.

Another example (e.g. example 19) relates to a previously described example (e.g. one of the examples 16 to 18) or any of the examples described herein and may further include transmitting the information related to the wager value and/or the signal initiating play of the game to a gaming server and receiving information regarding random selections of one or more symbols of the plurality of symbols from the gaming server.

Another example (e.g. example 20) relates to a previously described example (e.g. one of the examples 16 to 19) or any of the examples described herein and may further include that causing display of the random selection of one or more symbols of the plurality of symbols or the new random selection of one or more symbols of the plurality of symbols in the matrix of symbol positions comprises spinning reel strips comprising symbols of the plurality of symbols and randomly stopping the reel strips so as to display symbols of the reel strips in intersections (or positions) of the matrix of symbol positions.

Another example (e.g. example 21) relates to a previously described example (e.g. one of the examples 16 to 20) or any of the examples described herein and may further include that the collect signal is generated by a user (or player) triggering a button so as to collect the outcome of the game (or game outcome or award or win).

Another example (e.g. example 22) relates to a previously described example (e.g. one of the examples 16 to 21) or any of the examples described herein and may further include that receiving the collect signal does not stop the display and processing of the new random selection of one or more symbols of the plurality of symbols in the matrix of symbol positions until the crash symbol is displayed in a position of the matrix of symbol positions but stops adding the assigned multiplier value of the at least one multiplier symbol to the multiplier value memory of subsequent displays of the at least one multiplier symbol in positions of the matrix of symbol positions.

Another example (e.g. example 23) relates to a previously described example (e.g. example 22) or any of the examples described herein and may further include that, after receiving the collect signal, the assigned multiplier value of the at least one multiplier symbol of subsequent displays of the at least one multiplier symbol in positions of the matrix of symbol positions is added to the multiplier value memory together with a note as being added after the stop of play of the game or to a second multiplier value memory.

Another example (e.g. example 24) relates to a gaming apparatus comprising means for carrying out the method of a previously described example (e.g. one of the examples 16 to 23) or any of the examples described herein.

Another example (e.g. example 25) relates to a computer program comprising instructions, which when the computer program is executed by a computer, cause the computer to carry out the method of a previously described example (e.g. one of the examples 16 to 23) or any of the examples described herein.

Another example (e.g. example 26) relates to a non-transitory, computer-readable storage medium storing a plurality of instructions, which when executed by a processor, causes the processor to perform the method of a previously described example (e.g. one of the examples 16 to 23) or any of the examples described herein.

An example (e.g. example 27) relates to a system or a gaming system, comprising a gaming device comprising the computer-readable storage medium according to a previously described example (e.g. example 26) or the computer program according to a previously described example (e.g. example 25), and a gaming server comprising a random number generator for generating information regarding random selections of one or more symbols of the plurality of symbols.

The aspects and features described in relation to a particular one of the previous examples may be combined with one or more of the further examples to replace an identical or similar feature of that further example or to additionally introduce the features into the further example.

The methodologies described herein may be implemented by various means depending upon applications according to particular examples. For example, such methodologies may be implemented in hardware, firmware, software, or combinations thereof. In a hardware implementation, for example, the controller or processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Unless specifically stated otherwise, as apparent from the discussion herein, it is appreciated that throughout this specification discussions utilizing terms such as “processing,” “computing,” “calculating,” “determining” or the like refer to actions or processes of a processor, such as a processor on a special purpose computer or a similar special purpose electronic computing device. In the context of this description, therefore, a special purpose computer or a similar special purpose electronic computing device is capable of manipulating or transforming signals, typically represented as physical electronic or magnetic quantities within memories, registers, or other information storage devices, transmission devices, or displays of the special purpose computer or similar special purpose electronic computing device.

For clarity in discussing the various functions of the system, multiple computers and/or servers are discussed as performing different functions. These different computers (or servers) may, however, be implemented in multiple different ways such as modules within a single computer, as nodes of a computer system, etc. The functions performed by the system (or nodes or modules) may be centralized or distributed in any suitable manner across the system and its components, regardless of the location of specific hardware. Furthermore, specific components of the system may be referenced using functional terminology in their names. The function terminology is used solely for purposes of naming convention and to distinguish one element from another in the following discussion. Unless otherwise specified, the name of an element conveys no specific functionality to the element or component. It should be appreciated that, optionally, the software, hardware, and associated components of the system may be programmed and configured to implement one or more embodiments described herein. It should also be appreciated that the various aspects of the system may be exemplified as software, modules, nodes, etc., of a computer or server.

The gaming systems and methods described herein may be implemented in various configurations for gaming machines, gaming devices, or gaming systems, including but not limited to: (1) a dedicated gaming machine, gaming device, or gaming system wherein the computerized instructions for controlling any games (which may be provided by the gaming machine or gaming device) are provided with the gaming machine or gaming device prior to delivery to a gaming establishment; and (2) a changeable gaming machine, gaming device, or gaming system wherein the computerized instructions for controlling any games (which may be provided by the gaming machine or gaming device) are downloadable to the gaming machine or gaming device through a data network after the gaming machine or gaming device is in a gaming establishment. Optionally, the computerized instructions for controlling any games are executed by at least one central server, central controller, or remote host. In such “thin client” embodiments, the central server remotely controls any games (or other suitable interfaces) and the gaming system is utilized to display such games (or suitable interfaces) and/or receive one or more inputs or commands from a user (or player). Optionally, the computerized instructions for controlling any games are communicated from the central server, central controller, or remote host to a gaming device local processor and memory devices. In such “thick client” embodiments, the gaming device local processor executes the communicated computerized instructions to control any games (or other suitable interfaces) provided to a user (or player).

Examples may further be or relate to a (computer) program including a program code to execute one or more of the above methods when the program is executed on a computer, processor, or another programmable hardware component. Thus, steps, operations, or processes of different ones of the methods described above may also be executed by programmed computers, processors, or other programmable hardware components. Examples may also cover program storage devices, such as non-transitory digital data storage media, which are machine-, processor-or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. They may include any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

The terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware and/or software component.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps,-functions,-processes, or-operations.

If some aspects have been described in relation to a device or system, these aspects should also be understood as a description of the corresponding method. For example, a block, device, or functional aspect of the device or system may correspond to a feature, such as a method step, of the corresponding method. Accordingly, aspects described in relation to a method shall also be understood as a description of a corresponding block, a corresponding element, a property, or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A device, comprising:
a display device;
a processor arrangement comprising at least one processor; and
a memory arrangement for storing a plurality of instructions, which when executed by the processor arrangement, causes the processor arrangement to:
cause the display device to display a graphical environment comprising a matrix of symbol positions for displaying a plurality of symbols, wherein the matrix of symbol positions is formed by intersections of at least one row intersecting a plurality of columns or at least one column intersecting a plurality of rows and wherein the plurality of symbols comprises a crash symbol and at least one multiplier symbol that is assigned a multiplier value;
receive information related to a wager value for play of a game;
receive a signal initiating play of the game;
cause display of random selections of one or more symbols of the plurality of symbols in the matrix of symbol positions;
if the at least one multiplier symbol is displayed in the matrix of symbol positions, add the assigned multiplier value of the at least one multiplier symbol to a multiplier value memory;
stop play of the game if the crash symbol is displayed in the matrix of symbol positions or if a collect signal is received;
cause display of an outcome of the game.

2. The device according to claim 1, wherein display of random selections of one or more symbols of the plurality of symbols in the matrix of symbol positions comprises, in each position of the matrix of symbol positions, spinning a reel strip comprising symbols of the plurality of symbols and randomly stopping the reel strip so as to display one of the symbols of the reel strip.

3. The device according to claim 2, wherein all spinning reel strips are stopped if the crash symbol is displayed in a position of the matrix of symbol positions.

4. The device according to claim 2, wherein the spinning of the reel strip resumes if the crash symbol is not displayed in a position of the matrix of symbol positions.

5. The device according to claim 4, wherein the spinning of the reel strip resumes after a pause if the reel strip displays the at least one multiplier symbol.

6. The device according to claim 5, wherein a length of the pause depends on the assigned multiplier value of the displayed at least one multiplier symbol.

7. The device according to claim 1, wherein simultaneous and/or successive displays of the at least one multiplier symbol in positions of the matrix of symbol positions causes adding of the assigned multiplier value of the at least one multiplier symbol to the multiplier value memory for each display of the at least one multiplier symbol in a position of the matrix of symbol positions.

8. The device according to claim 1, wherein the plurality of symbols comprises more than one multiplier symbol that differ in the assigned multiplier value.

9. The device according to claim 1, wherein receiving the collect signal does not stop the display of random selections of one or more symbols of the plurality of symbols in the matrix of symbol positions until the crash symbol is displayed in a position of the matrix of symbol positions but stops adding the assigned multiplier value of the at least one multiplier symbol to the multiplier value memory of subsequent displays of the at least one multiplier symbol in positions of the matrix of symbol positions.

10. The device according to claim 9, wherein, after receiving the collect signal, the assigned multiplier value of the at least one multiplier symbol of subsequent displays of the at least one multiplier symbol in positions of the matrix of symbol positions is added to the multiplier value memory together with a note as being added after the stop of play of the game or to a second multiplier value memory.

11. The device according to claim 1, wherein display of the outcome of the game comprises addition of assigned multiplier values that were added to the multiplier value memory before receipt of the collect signal and display of a value of the addition in the graphical environment.

12. The device according to claim 1, wherein display of the outcome of the game comprises determining an award and display of the award in the graphical environment if play of the game was stopped by receipt of the collect signal.

13. The device according to claim 12, wherein determining the award comprises addition of assigned multiplier values that were added to the multiplier value memory before receipt of the collect signal and multiplication of a value of the addition with the wager value.

14. The device according to claim 1, wherein the outcome of the game is displayed in the graphical environment for a plurality of preceding plays of the game.

15. The device according to claim 14, wherein display of the outcome of the game for the plurality of preceding plays of the game comprises, for each play of the plurality of preceding plays of the game, addition of assigned multiplier values that were added to the multiplier value memory during a single play of the plurality of preceding plays of the game and display of a value of the addition in the graphical environment.

16. The device according to claim 15, wherein the value of the addition of each play of the plurality of preceding plays of the game is displayed in a list in chronological order of the preceding plays of the game.

17. The device according to claim 1, wherein the processor arrangement is configured to:
receive, via interface control circuitry in communication with a user input interface, the information related to the wager value and the signal initiating play of the game,
wherein the processor arrangement causes display of random selections of one or more symbols of the plurality of symbols in the matrix of symbol positions in the graphical environment based on the signal initiating play of the game.

18. The device according to claim 1,
wherein the processor arrangement causes generation of the outcome of the game based on the information related to the wager value, the assigned multiplier values that were added to the multiplier value memory, and receipt of the collect signal.

19. A method of operating a device, the method comprising:
causing display of a graphical environment comprising a matrix of symbol positions for displaying a plurality of symbols, wherein the matrix of symbol positions is formed by intersections of at least one row intersecting a plurality of columns or at least one column intersecting a plurality of rows and wherein the plurality of symbols comprises a crash symbol and at least one multiplier symbol that is assigned a multiplier value;
receiving information related to a wager value for play of a game;
receiving a signal initiating play of the game;
causing display of random selections of one or more symbols of the plurality of symbols in the matrix of symbol positions;
if the at least one multiplier symbol is displayed in the matrix of symbol positions, adding the assigned multiplier value of the at least one multiplier symbol to a multiplier value memory;
stopping play of the game if the crash symbol is displayed in the matrix of symbol positions or if a collect signal is received; and
causing display of an outcome of the game.

20. A non-transitory, computer-readable storage medium storing a plurality of instructions, which when executed by a processor, causes the processor to perform the method of claim 19.
